(19) United States
(12) Patent Application Publication
(10) Pub. No.: US 2008/0130571 A1
(43) Pub. Date: Jun. 5, 2008

(54) HANDOVER IN A MOBILE NETWORK DOMAIN

(75) Inventors: Masahiro Maeda, Tokyo (JP); Ryutaro Hamasaki, Tokyo (JP)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/566,704

(22) Filed: Dec. 5, 2006

(51) Int. Cl. H04Q 7/36

(52) U.S. Cl. 370/331

(57) ABSTRACT

A mobile network domain (101) comprises a mobility anchor node (105) providing a non-mobile network attachment and at least a first and second access router (107, 109) supporting access by mobile nodes (127). The nodes of the mobile network domain (101) support label encapsulated tunneling. Label switching paths (121, 129) are established between the mobility anchor node (105) and the access routers (107, 109) as well as between the access routers (107, 109) themselves. When a handover of a mobile node (127) from the first access router (107) to the second access router (109) is detected, the first access router (107) forwards data packets for the mobile node (127) received via a first label switching path (121) to the second access router (109) via a direct label switching path (129) between the access routers (107, 109). The forwarded data packets are label encapsulated tunneling data packets. The invention may for example combine NetLMM (Network based Local Mobility Management) and MPLS (Multi-Protocol Label Switching) techniques to provide better performance and handover.

### FIELD OF THE INVENTION

The invention relates to handover in mobile networks and in particular to handover in mobile network domain using label encapsulated tunneling.

### BACKGROUND OF THE INVENTION

Data communication using wired and/or wireless data networks are becoming increasingly important and ubiquitous as evidenced by the popularity and growth of the Internet. At the same time, device mobility is becoming increasingly important and there is a current trend towards increased support for mobility in data networks.

The Internet Engineering Task Force (IETF) is responsible for standardising the Internet Protocol (IP) used e.g. by the Internet. In order to provide mobility, the IETF has standardised IP mobility protocols (referred to as Mobile IP) for different versions of IP. In particular, Mobile IP has been standardised for IP version 4 (IPv4) in RFC3344—IP Mobility Support for IPv4 and for IP version 6 (IPv6) in RFC3775—Mobility Support in IPv6. Mobile IP provides invariable IP addresses to mobile hosts which are moving within the IP network.

However, Mobile IP has a number of disadvantages. Specifically, Mobile IP requires a lot of modifications to existing IP stacks for mobile hosts. Furthermore, it requires mobile hosts to be involved in substantial amounts of mobility related signalling thereby increasing the overhead. Furthermore, Mobile IP requires complex operations and signalling when a mobile node hands over between different access nodes.

In many cases, it is advantageous to implement a network based mobility approach which can minimize the involvement of mobile hosts. For this purpose a Network based Local Mobility Management (NetLMM) working group was formed by the IETF. The proposed NetLMM approach is based on generating a Local Mobility Domain (LMD) which comprises a Local Mobility Agent (LMA) as well as a number of Access Routers (ARs—also referred to as a Mobile Access Gateway (MAG)). The LMD may further comprise a number of routers for routing data between ARs and the LMA.

In the NetLMM approach, the LMA anchors the movement of mobile nodes such that all mobile nodes supported by the ARs of the LMD can be reached by sending data packets to the LMA. The data packets may then be routed to the appropriate access router using IPv6-in-IPv6 tunneling or GRE (Generic Routing Encapsulation) tunneling which is a generic method for encapsulating network protocol data over another network protocol layer as defined in RFC2784—Generic Routing Encapsulation.

However, this approach tends to be suboptimal and in particular tends to be relatively complex and to have a high overhead. Specifically, using GRE and/or IPv6-in-IPv6 tunneling, the encapsulation overhead will be relatively large. E.g. in IPv6-in-IPv6 tunneling, the encapsulation header will be at least 40 bytes. In GRE with IPv6 as the delivery protocol, the total encapsulation header will be more than 44 bytes.

Also, the NetLMM approach tends to result in suboptimal handover performance when a mobile node moves from being supported by one LMA to being supported by another. This handover tends to be relatively slow and to result in a retransmission of data within the LMD thereby resulting in increased resource usage. Specifically, during a handover, the mobile node may observe packet losses due to the delay in establishing link layer and network layer connectivity. The LMA can provide a smoother handover by buffering data packets and then re-transmitting the buffered data packets on receiving a request from the mobile node. As the handover delay is variable, the size of the LMA buffer must be large enough to prevent any possible packet loss. However, if the buffer is large, there will be unnecessary retransmission of packets, which will result in delays and wasted resources.

Hence, an improved system would be advantageous and in particular a system allowing increased flexibility, reduced complexity, reduced overhead, improved handover performance and/or improved mobility performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a mobile network domain for supporting mobile nodes; the mobile network domain comprising: a mobility anchor node providing a non-mobile network attachment to the mobile network domain, the mobility anchor node being arranged to support label encapsulated tunneling of data packets to nodes of the mobile network domain; at least a first and second access routers supporting access by mobile nodes, the first and second access router being arranged to receive data packets by label encapsulated tunneling; path means for setting up a first label switching path between at least the mobility anchor node and the first access router and a second label switching path between the first access router and the second access router; and means for detecting a handover of a mobile node from the first access router to the second access router; and wherein the first access router is arranged to forward data packets for the mobile node received via the first label switching path to the second access router via the second label switching path in response to the handover detection; the data packets transmitted on the first and second label switching path being label encapsulated tunneling data packets.

The invention may allow improved mobility performance. In particular, an improved handover performance may be achieved in many scenarios. The invention may allow a reduced data overhead and may specifically in many embodiments reduce buffering and data retransmission requirements associated with a handover

The first access router may forward the data packets over the second label switching path by including a label of a node of the second label switching path in the label encapsulation of the received data packets. Specifically, the first access router may replace a label for the first access router with a label for the second access router. The label for the second access router may be the label of the second access router itself or a label of an intermediate node of the second label switching path.

According to an optional feature of the invention, the mobility anchor node is arranged to encapsulate data packets for the mobile node by including a label encapsulation comprising an inner label of the mobile node and an outer label of a node of the first label switched path.

This may provide efficient, reliable and/or low overhead operation and/or may facilitate implementation.

The outer label may be a label of the first access router or a label of an intermediate node of the first label switching path. Specifically, it may be a label of the first node in the first label switching path from the mobility anchor node to the first access router. Intermediate nodes of the first label switching path, such as e.g. Label Switching Routers, may be arranged to replace the outer label of a received data package with the label of the next node in the first label switching path. The next node may be the first access router or may be a following intermediate node.

According to an optional feature of the invention, the first access router is arranged to identify a label of the second access router in response to receiving a handover target indication for a base station served by the second access router.

This may provide efficient, reliable and/or low overhead operation and/or may facilitate implementation.

The handover target indication may be a handover triggering message initiating the handover process. The handover target indication may specifically be a layer 2 handover triggering message. The handover target indication may indicate an identity of the base station such as a base station ID or an IP address of the base station.

In some embodiments, the first access router may setup the forwarding of the data packets to the second access router upon receiving a handover triggering message but may not start forwarding data packets until a detach message is received for the mobile node.

According to an optional feature of the invention, the first access router is arranged to identify a label of the second access router in response to receiving a handover message comprising a network address indication for the second access router.

This may provide efficient, reliable and/or low overhead operation and/or may facilitate implementation. The network address indication may be an indication of an IP or MAC address of the second access router.

According to an optional feature of the invention, the path means is arranged to set up a third label switching path between the mobility anchor node and the first access router, and the mobility anchor node is arranged to forward data packets to the second access router via the third label switching path following the handover.

This may provide efficient, reliable and/or low overhead operation and/or may facilitate implementation. In particular, it may allow efficient routing following the handover while allowing performance degradation during the handover to be reduced.

According to a second aspect of the invention, there is provided method of handover in a mobile network domain supporting mobile nodes; the mobile network domain comprising: a mobility anchor node providing a non-mobile network attachment to the mobile network domain, the mobility anchor node being arranged to support label encapsulated tunneling of data packets to nodes of the mobile network domain; at least a first and second access routers supporting access by mobile nodes, the first and second access router being arranged to receive data packets by label encapsulated tunneling; the method comprising: setting up a first label switching path between at least the mobility anchor node and the first access router and a second label switching path between the first access router and the second access router; and detecting a handover of a mobile node from the first access router to the second access router; and the first access router forwarding data packets for the mobile node received via the first label switching path to the second access router via the second label switching path in response to the handover detection; the data packets transmitted on the first and second label switching path being label encapsulated tunneling data packets.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a mobile network comprising a mobile network domain in accordance with some embodiments of the invention;

FIG. 2 illustrates an example of a label switching setup procedure for a mobile network domain in accordance with some embodiments of the invention;

FIG. 3 illustrates an example of a data and signalling flow in a mobile network domain in accordance with some embodiments of the invention;

FIG. 4 illustrates a mobile network comprising a mobile network domain in accordance with some embodiments of the invention;

FIG. 5 illustrates an example of a data and signalling flow in a mobile network domain in accordance with some embodiments of the invention;

FIG. 6 illustrates a mobile network comprising a mobile network domain in accordance with some embodiments of the invention; and

FIG. 7 illustrates a method of handover in a mobile network domain in accordance with some embodiments of the invention.

### DETAILED DESCRIPTION OF SOME EMBODIMENTS OF THE INVENTION

The following description focuses on embodiments of the invention applicable to a NetLMM mobile network domain. However, it will be appreciated that the invention is not limited to this application but may be applied to many other protocols and networks.

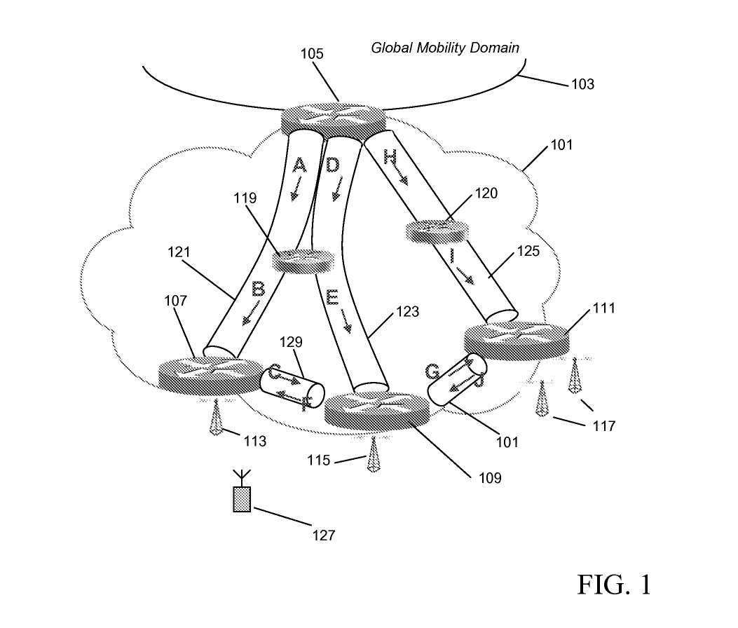

FIG. 1 illustrates a mobile network in accordance with some embodiments of the invention.

The mobile network comprises a mobile network domain in the form of a NetLMM Local Mobility Domain (LMD) 101. The LMD 101 connects to another network domain, which may e.g. be a non-mobile network domain or a global network domain 103, via a NetLMM Local Mobility Agent (LMA) 105 which provides a mobility anchor for mobile nodes within the LMD 101. In the example, the global network domain 103 is an IP network. In the system, the LMA 105 is thus a mobility anchor node which operates as a mobility anchor such that any network node in the global network domain 103 will transmit data for mobile nodes supported by the LMD 101 to the LMA 105. Hence, all IP addresses for the mobile nodes supported by the LMD 101 are routed to the LMA 105 and the LMA 105 thus provides a non-mobile network attachment to the LMD 101.

The LMD 101 comprises a number of NetLMM Access Routers (ARs) 107, 109, 111 which are coupled to a number of wireless access points or base stations 113, 115, 117. The LMD 101 supports wireless Mobile Nodes (MNs) which may move and change their access points to the network (only one MN 127 is shown in FIG. 1). The MNs may specifically handover between different base stations belonging to the same or different ARs.

In the system, data packets for the MNs supported by the LMD 101 are in the global network domain 103 routed to the LMA 105 from where they are routed to the AR currently supporting the MN. In the system, the data packets are routed in the LMD 101 using label encapsulated tunneling and specifically by using the Multi-Protocol Label Switching (MPLS) standard. In MPLS, data packets are tunneled by encapsulating them by prepending packets with an MPLS header. The header contains one or more labels associated with network nodes of a routing path and the routing of the data packet is performed in response to the labels of the label encapsulation header. Specifically, in MPLS, labelled data packets are forwarded by routers after a Label Lookup/Switch instead of a lookup into the IP table. The MPLS protocol is specified in RFC3031—Multiprotocol Label Switching Architecture and RFC3032—MPLS Label Stack Encoding.

Thus, rather than using IP routing and specifically Mobile IP, an LMD 101 is established which has a single anchor point thereby facilitating mobility support by the global network domain 103. The routing within the LMD 101 is substantially facilitated by using MPLS and specifically the data overhead is much reduced by using a low overhead label encapsulated tunneling of the IP data packets.

In the example, the LMD furthermore comprises a number of Label Switched Routers (LSRs) 119, 120. The LSRs 119, 120 are capable of routing the label encapsulated tunneling IP data packets and are in the specific example of FIG. 1 connected between the LMA 105 and the ARs 107, 109, 111.

In the system, routing of data packets to the MNs are supported by Label Switched Paths (LSPs) along which the data packets are forwarded. In particular, an LSP 121, 123, 125 is setup between the LMA 105 and each of the ARs 107, 109, 111 in the LMD 101. The LSPs 121, 123, 125 may include none, one or more LSRs 119, 120.

For example, a first MN 127 may currently be served by a first base station 113 coupled to a first AR 107. Accordingly, any IP data packet received at the LMA 105 and addressed to the IP address of the first MN 127 will be encapsulated with labels for a first LSP 121 setup between the LMA 105 and the first AR 107. The label encapsulated tunneling data packets are then routed to the first AR 107 using MPLS label switching routing techniques. In the example of FIG. 1, the first LSP 121 comprises a first LSR 119 which is also included in a second LSP 123 between the LMA 105 and a second AR 109.

The LSPs 121, 123, 125 may be static LSPs which are pre-configured between the LMA 105 and each AR 107, 109, 111 by a network operator or administrator. Alternatively or additionally, one or more of the LSPs can be established during an association phase between ARs and the LMA. In such an association phase, the LMA and ARs can exchange association requests and acknowledgement messages to exchange the required information before they start to provide the mobility service to MNs.

In addition to the LSPs 121, 123, 125 between the LMA 105 and the ARs 107, 109, 111, LSPs 129, 131 are also setup between neighbouring ARs i.e. between ARs which have neighbouring base stations such that a MN may handover between these base stations (and thus the corresponding ARs). For example, in FIG. 1, the base station 113 connected to the first AR 107 and currently supporting the first MN 127 is a neighbour of a second base station 115 connected to the second AR 109. Thus, the first MN 127 may handover between the first base station 113 and the second base station 115 and thus between the first AR 107 and the second AR 109. Accordingly, a direct LSP 129 is setup between the first and second AR 107, 109.

Similarly to the LSPs 121, 123, 125 between the LMA 105 and the ARs 107, 109, 111, the LSPs 129, 131 between the ARs 107, 109, 111 may also be static LSPs or may e.g. be set up during an association phase.

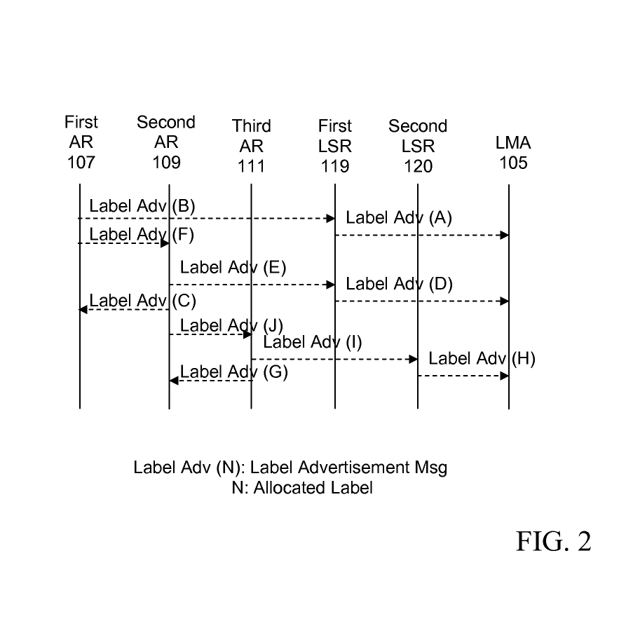

FIG. 2 illustrates an example of a LSP setup procedure. Specifically, the ARs 107, 109, 111 transmit label advertisement messages to the connected LSRs 119, 120 with information of the label allocated to the respective AR for this LSP. Similarly, the LSRs 119, 120 forward label advertisement messages to the LMA 105 informing this of the label allocated to the respective LSPs of the respective LSRs 119, 120. In addition, neighbouring ARs 107, 109, 111 exchange label advertisement messages between each other in order to exchange label information setting up direct LSPs between the ARs 107, 109, 111.

In response to the label advertisement messages, the network nodes are setup to perform the label encapsulated tunneling. Specifically, the LMA 105 is configured to encapsulate a data packet for the first AR 107 by including (pushing) the label A for the first LSR 119 when part of the first LSP 121 in a label encapsulation header as the first LSR 119 is the first node of the first LSP 121 between the LMA 105 and the first AR 107.

Similarly, the first LSR 119 is arranged to receive encapsulated data packets from the LMA 105. If the data packet comprises the label of the first LSP 121 (i.e. the label A) it replaces this label by the label associated with the next node of the first LSP 121 i.e. in the example of FIG. 1 the label B replaces label A in the encapsulation.

Furthermore, the first AR 107 is arranged to remove (pop) labels associated with the first AR 107 before transmitting the data packets to the MNs. Thus, the over-the-air routing can be performed based on the network identity, e.g. based on the IP address of the MNs and the use of label encapsulation in the LMD becomes transparent to the MNs.

The LSPs can thus be preconfigured such that label tunneling of data packets can be achieved quickly and efficiently.

It will be appreciated that any approach or method for setting up the LSPs may be used without detracting from the invention. In particular, it will be appreciated that any suitable protocol for exchanging label advertisement messages may be used.

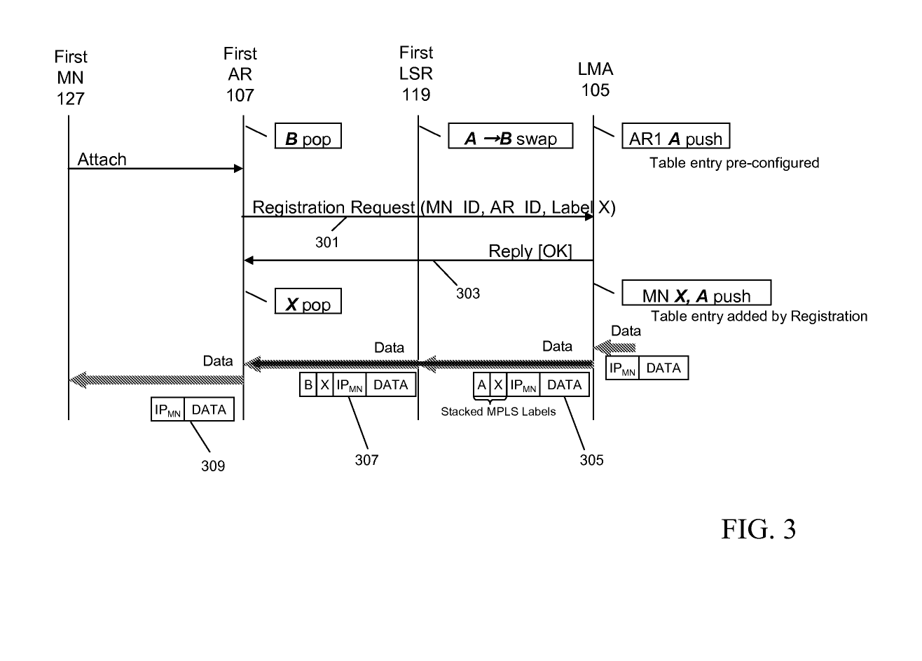

FIG. 3 illustrates an example of a registration and tunneling procedure used in the LMD 101.

Specifically, in the example, the first MN 127 attaches to a first base station 113 which is served by the first AR 107. In response, the first AR 107 allocates a label X to the first MN 127. The allocated label is unique for the first AR 107 but may be reused by other ARs. In response to the attachment, the first AR 107 generates a Registration Request (RR) message 301 which includes a network identifier for both the first AR 107 and the first MN 127 and transmits this to the LMA 105. The identifier of the first MN 127 and the first AR 107 is in the specific example IP addresses but may in other embodiments be e.g. an Ethernet MAC address or a Network Access Identifier as defined in RFC4282.

When receiving the RR message 301, the LMA 105 returns an acknowledge message 303 and also proceeds to associate the identifier of the first MN 101 with the label stored for the first LPS 121 to the first AR 107. In addition, the LMA configures the label encapsulation to include the label X of the first MN 101 when encapsulating data packets received for the IP address of the first MN 101.

Specifically, when receiving the RR message 301, the LMA 105 creates or updates an MPLS table entry for the first MN 127 to push two labels onto data packets for the first MN 127. The outer label is a copy of the label that is pre-configured for the path to the first AR 107 i.e. in the specific example the outer label is the label A of the first LSR 119 when part of the first LSP 121. The inner label is the label allocated to the first MN 127 X as indicated in the RR message 301. Therefore, the inner label is unique to the MN within the AR serving it and the outer label is unique to the path to the serving AR.

When the LMA 105 receives data packets for the first MN 101, it proceeds to prepend two MPLS label headers to the packets and to forward them to the first AR 107 by label encapsulated tunneling along the first LSP 121. In the LMD 101, MPLS labelled packets are forwarded by intermediate LSRs 119, 120 between the LMA 105 and the ARs 107, 109, 111 based on the outer label. In the specific example, the first LSR 119 receives a label encapsulated data packet 305 and replaces the label A of the first LSR 119 with the label B of the first AR 107 and then forwards the modified data packet 307 to the first AR 107. However, the first LSR 121 does not modify or delete the inner label but rather maintains the label for the first MN 127 in the label encapsulation.

When the first AR 107 receives an encapsulated packet for the first MN 127, it removes the label encapsulation and transmits the resulting data packet 309 to the first MN 127. Thus, the first MN 127 receives a standard IP data packet.

Specifically, the outer MPLS label is removed as the outer label indicates the pre-configured first LSP 121 which terminates at the first AR 107. It then processes the inner label to identify the appropriate MN. Thus, the inner label is the MN unique label and this is also removed at the first AR 107 before the payload data packet 309 is forwarded to the first MN 127. In this way the ARs 107, 109, 111 can remove label encapsulation data from the data packets prior to forwarding these to the MNs thereby reducing the over the air resource consumption and providing a standard non-encapsulated IP data packet to the MNs.

In the system, handover between neighbouring base stations 113, 115, 117 belonging to neighbouring ARs 107, 109, 111 are executed using the LSPs setup directly between the ARs 107, 109, 111.

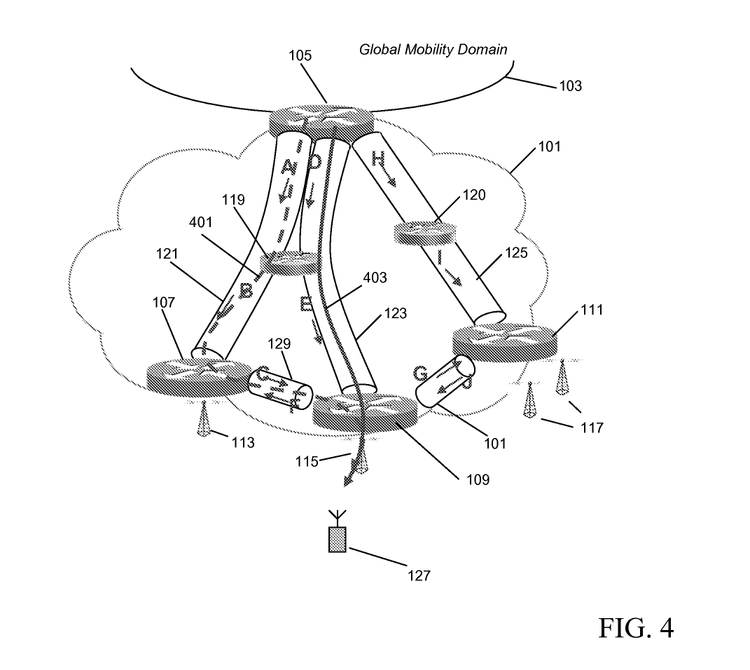

For example, FIG. 4 illustrates the network of FIG. 1 where the first MN 127 has moved such that a handover has been performed from the first base station 113 to the second base station 115 served by the second AR 109. However, merely reconfiguring the LMA 105 to forward the received data packets along the second LSP 123 to the second AR 109 will result in a delay in which data packets are still being routed to the first AR 107. These data packets will be lost and need to be requested by the first MN 127 for retransmission over the second LSP 123. Such an approach results in delays and inefficient handover performance with additional overhead.

In the LMD 101, data packets tunneled to an AR from which a MN has handed over may be directly forwarded to the AR to which the MN has handed over using label encapsulated tunneling. In the specific example, during the handover of the first MN 127 from the first AR 107 to the second AR 109, the data packets are transmitted from the LMA 105 to the first AR 107. The first AR 107 is then arranged to include a suitable label for the direct LSP 129 between the first and second AR 107, 109. The first AR 107 then forwards the label encapsulated tunneling data packets to the second AR 109 using label encapsulated tunneling.

Specifically, the first AR 107 may detect that a handover of the first MN 127 is taking place by detecting a detachment message transmitted by the first MN 127. In response, the first AR 107 can change its operation such that instead of removing the label encapsulation header(s), it merely modifies this to include the label of the direct LSP 129, i.e. in the specific example it removes label B (and possibly X) of the first AR 107 in the first LSP 121 and instead adds the label of the second AR 109 in the direct LSP 129. The data packets will then be forwarded directly to the second AR 109 using label switching.

The second AR 109 may process the data packets received from the first AR 107 in the same way as data packets received from the LMA 105. Specifically, it can use the IP address of the first MN 127 to identify which MN to transmit the data packet to. In addition, it can remove the label encapsulation header before transmitting the payload data packet to the first MN 127. Thus, the data packets are transmitted to the first MN 127 without any (or with reduced) requirement for retransmission thereby resulting in substantially reduced resource usage and reduced delay.

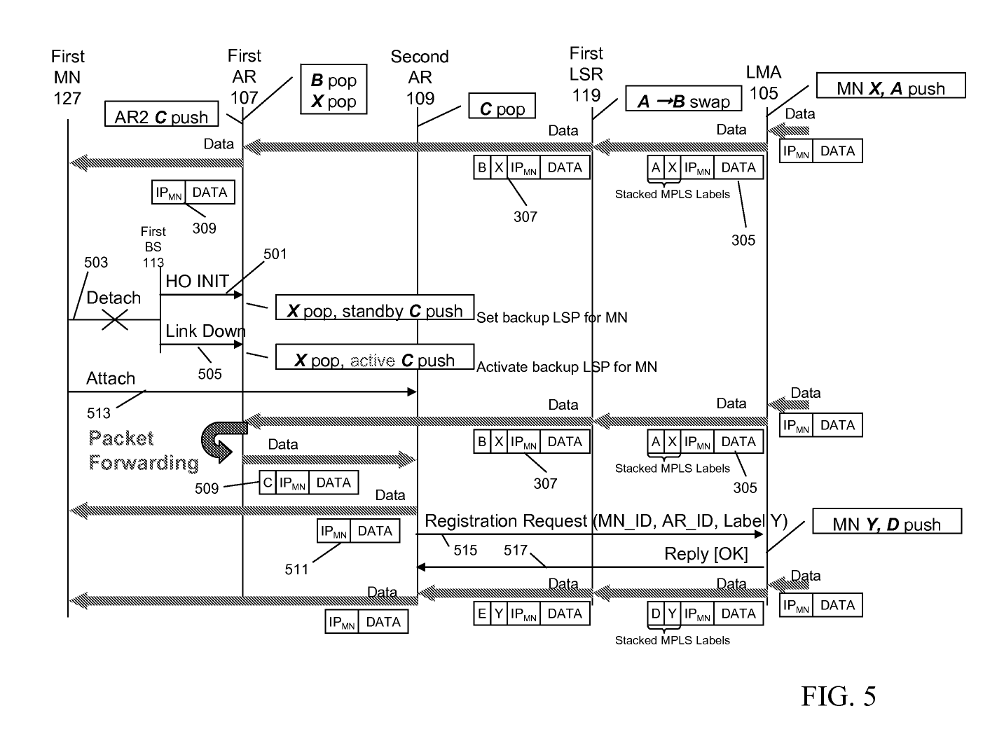

A specific example of a handover will be described with reference to FIG. 5. In the example, the first access router comprises means for identifying the AR and LSP to use for forwarding in response to receiving an indication of a handover being initiated with an identification of the target base station for the handover.

Specifically, prior to the handover, the data packets are tunneled from the LMA 105 to the first AR 107 using label encapsulation as previously described and illustrated in FIG. 3. Furthermore, the first AR 107 is pre-configured to include the label C of the direct LSP 129 in data packets if these are to be forwarded to the second AR 109 during a handover.

At some stage, a handover is initiated of the first MN 127 from the first base station 113 served by the first AR 107 to the second base station 115 served by the second AR 109. As part of this process, the first AR 107 receives a handover target indication which identifies that a handover attempt is initiated and furthermore comprises a network identification of the second base station 115. Alternatively or additionally, a handover target message indicating that a handover to the second AR 109 is initiated may be received. This message may indicate a network address of the second AR 109 such as an IP or MAC address of the second AR 109.

Specifically, the handover target indication may be received as a Layer 2 triggering message 501 which comprises a base station ID or IP address of the second base station 115. The Layer 2 triggering message 501 is a message sent by a Layer 2 node (specifically the first base station 113) which triggers the handover network layer protocol procedure.

In response to receiving the triggering message 501, the first AR 107 proceeds to identify the AR associated with the base station identity and therefrom it determines the appropriate LSP and label to use when forwarding data packets. In the specific example, the second AR 109 is identified and accordingly a label switching table entry indicating that the label C of the direct LSP 129 should be included (pushed) for data messages to the first MN 127 is generated.

However, in the specific example, the first AR 107 does not immediately start to forward the label encapsulated data packets to the second AR 109. Rather, the forwarding is only initialised as a stand-by/back-up route and the first AR 107 temporarily continues to transmit the data packets to the first MN 127 via the first base station 113.

At some stage, the first MN 127 detaches from the first base station 113. This detachment may for example be triggered by the first MN 127 transmitting a detachment message 503 to the fist base station 113 or may e.g. be initiated by the first base station 113 detecting that the air interface link is no longer supported. In response, the first base station 113 generates a detachment message 505 (such as a Link Down message) and transmits this to the first AR 107. In response, the first AR 107 immediately starts to forward the data packets to the second AR 109 using label encapsulation. Thus, the standby routing is made active and the first AR 107 proceeds to pop the label encapsulation data (labels B and X) from the received label encapsulated data packets and instead push the label C to the encapsulation header. The modified encapsulated data packets 507 are then transmitted to the second AR 109 via the direct LSP 129.

When the second AR 109 receives the label encapsulated data packets 507 on the direct LSP 129 it proceeds to remove the label encapsulation header (label C) and to transmit the resulting original IP data packet 511 to the first MN 127 via the second base station 115.

Thus, even before a direct routing of data packets to the second AR 109 is setup, the data packets for the first MN 127 are routed to the second base station 115 via the first AR 107. Thus, fewer (or no) data packets are lost during the handover and fewer (or no) data packets need to be retransmitted.

At some stage during the handover, the routing of data packets to the first MN 127 is changed such that the LMA 105 starts to encapsulate data packets such that the second LSP 123 is used for the first MN 127 rather than the first LSP 121. This, initialisation may be performed time independently of the forwarding process and may in particular be performed partly or fully in parallel to or after the initialisation and forwarding of data packets via the direct LSP 129.

Specifically, the forwarding routing path 401 via the first AR 401 may be used until a more direct routing path 403 via the second LSP has been setup by the LMA 105 and second AR 109.

In the example of FIG. 5, the first MN 127 transmits an attach message 513 to the second AR 109 when it has handed over to the second base station 115. In response, the second AR 109 and the LMA 105 proceeds to establish the direct routing path 403 similarly to the initial routing setup from the LMA 105 to the first AR 107 when the first MN 107 attached to the first AR 107.

Thus, the second AR 109 generates a Registration Request (RR) message 515 indicating the first MN 107 IP address, the second AR 109 IP address and a label Y allocated to the first MN 127 when attached to the second AR 109. The RR message 515 is transmitted to the LMA 105 which responds with an acknowledgement message 517. The LMA 105 also proceeds to associate the first MN 107 IP address with the labels D,Y appropriate for the label encapsulated tunneling via the second LSP 123. Thus, from this initialisation, the LMA 105 proceeds to prepend data packets for the first MN 127 by the label of the second LSR 120 of the second LSP 123 thereby ensuring that data packets are routed via the more direct routing path 403.

Thus, a more efficient and faster handover operation is achieved while maintaining a very low tunneling overhead.

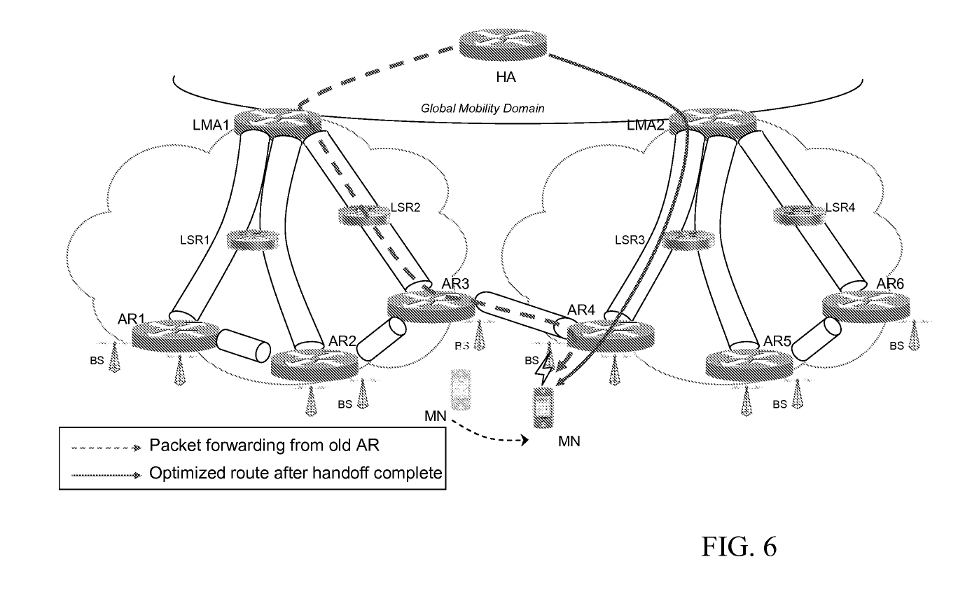

In some embodiments, the AR to which the handover is performed is supported by a different mobility anchor node (e.g. a different LMA) than the mobility anchor node (e.g. LMA) supporting the AR from which the MN is handed over. In such cases, the same principles may be applied i.e. a direct LSP may be configured between the two ARs of the handover and the data packets may be forwarded between the two ARs using label encapsulated tunneling. However, in such embodiments, the initialisation of the new routing path after the handover also involves one or more network nodes of the global network domain. An example of such a handover between domains of different mobility anchors is shown in FIG. 6.

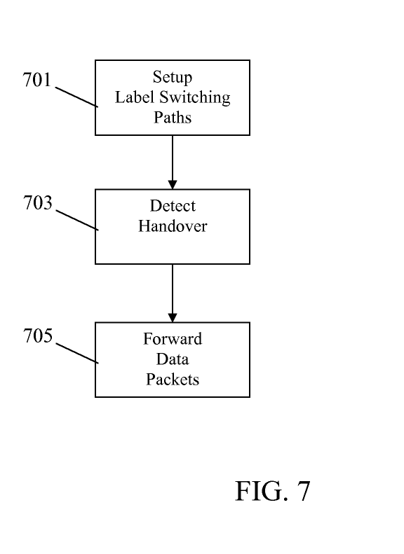

FIG. 7 illustrates a method of handover in a mobile network domain supporting mobile nodes. Specifically, the method may be used in a mobile network domain as described with reference to FIG. 1.

In step 701 a first label switching path is setup between a mobility anchor node and a first access router and a second label switching path is setup between the first access router and a second access router.

Step 701 is followed by step 703 wherein a handover of a mobile node from the first access router to the second access router is detected.

Step 703 is followed by step 705 wherein the first access router forwards data packets for the mobile node received via the first label switching path to the second access router via the second label switching path in response to the handover detection. The data packets transmitted on the first and second label switching path are label encapsulated tunneling data packets.

It will be appreciated that the described embodiments provide a number of advantages individually or combined including e.g. the following:
Reduced encapsulation overhead. E.g. even if stacked MPLS label encapsulation is used between the LMA and ARs, the overhead of encapsulation is typically 8 bytes compared to at least 40 bytes for most other encapsulations.
Reduced hand-over delay. Fewer data packets need to be requested by the MN for retransmission. Furthermore, as the forwarding handover procedure can be achieved within an AR the handover delay can be reduced. Route optimization can be performed at a later stage.
Reduced packet loss during handover. Since the packets sent from the LMA to the pre-handover AR are forwarded to the post handover AR, the packet loss can be minimized during handover
The fast handover approach is applicable to handovers between different local mobility domains.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A mobile network domain for supporting mobile nodes; the mobile network domain comprising:
a mobility anchor node providing a non-mobile network attachment to the mobile network domain, the mobility anchor node being arranged to support label encapsulated tunneling of data packets to nodes of the mobile network domain;
at least a first and second access routers supporting access by mobile nodes, the first and second access router being arranged to receive data packets by label encapsulated tunneling;
path means for setting up a first label switching path between at least the mobility anchor node and the first access router and a second label switching path between the first access router and the second access router; and
means for detecting a handover of a mobile node from the first access router to the second access router; and
wherein the first access router is arranged to forward data packets for the mobile node received via the first label switching path to the second access router via the second label switching path in response to the handover detection; the data packets transmitted on the first and second label switching path being label encapsulated tunneling data packets.

2. The mobile network domain of claim 1 wherein the mobility anchor node is arranged to encapsulate data packets for the mobile node by including a label encapsulation comprising an inner label of the mobile node and an outer label of a node of the first label switched path.

3. The mobile network domain of claim 1 wherein at least one of the first and the second access router comprises means for removing label encapsulation data from the data packets prior to forwarding the data packets to the mobile node.

4. The mobile network domain of claim 1 wherein the first label switching path comprises at least a first label switch router arranged to switch label encapsulated tunneling data packets.

5. The mobile network domain of claim 4 wherein the first label switch router is arranged to replace a label for the first label switch router by a label for a further node of the first label switched path in a label encapsulation of the data packets.

6. The mobile network domain of claim 4 wherein a label encapsulation of the data packets furthermore comprises a label for the mobile node and the first label switching router is arranged to maintain the label for the mobile node in the label encapsulation.

7. The mobile network domain of claim 1 wherein the first access router is arranged to identify a label of the second access router in response to receiving a handover target indication for a base station served by the second access router.

8. The mobile network domain of claim 1 wherein the first access router is arranged to identify a label of the second access router in response to receiving a handover message comprising a network address indication for the second access router.

9. The mobile network domain of claim 1 wherein the first access router is arranged to switch from forwarding the data packets to the mobile node to forwarding the data packets to the second access router in response to receiving a detachment message for the mobile node.

10. The mobile network domain of claim 1 wherein path means is arranged to set up a third label switching path between the mobility anchor node and the first access router, and the mobility anchor node is arranged to forward data packets to the second access router via the third label switching path following the handover.

11. The mobile network domain of claim 1 wherein the first access router is arranged to transmit an assigned label for the mobile node to at least one other node of the first label switching path in response to detecting an attach of the mobile node.

12. The mobile network domain of claim 11 wherein the at least one other node includes the mobility anchor node, the mobility anchor node being arranged to include the assigned label of the mobile node in a label encapsulation of data packets for the mobile node.

13. The mobile network domain of claim 1 wherein the path means comprises means distributed between different nodes and arranged to exchange label allocation information between the different nodes.

14. The mobile network domain of claim 1 wherein the second access router is supported by a different mobility anchor node than the mobility anchor node supporting the first access router.

15. The mobile network domain of claim 1 wherein the label encapsulation comprises a Multi-Protocol Label Switching, MPLS, header.

16. The mobile network domain of claim 1 wherein the mobility anchor node is a Network based Local Mobility Management, NetLMM, Local Mobility Anchor, LMA.

17. The mobile network domain of claim 1 wherein the label encapsulated tunneling data packets are label encapsulated tunneling Internet Protocol data packets.

18. A method of handover in a mobile network domain supporting mobile nodes; the mobile network domain comprising:
a mobility anchor node providing a non-mobile network attachment to the mobile network domain, the mobility anchor node being arranged to support label encapsulated tunneling of data packets to nodes of the mobile network domain;
at least a first and second access routers supporting access by mobile nodes, the first and second access router being arranged to receive data packets by label encapsulated tunneling;
the method comprising:
setting up a first label switching path between at least the mobility anchor node and the first access router and a second label switching path between the first access router and the second access router; and
detecting a handover of a mobile node from the first access router to the second access router; and
the first access router forwarding data packets for the mobile node received via the first label switching path to the second access router via the second label switching path in response to the handover detection;
the data packets transmitted on the first and second label switching path being label encapsulated tunneling data packets.
